(19) United States
(12) Patent Application Publication
(10) Pub. No.: US 2002/0178720 A1
(43) Pub. Date: Dec. 5, 2002

(54) High pressure hydrualic system within a single housing

(76) Inventors: Willibald G. Berlinger, Peoria, IL (US); Francis J. Raab, Chillicothe, IL (US)

Correspondence Address: Taylor & Aust, P.C., ATTN: Todd T. Taylor, 142 South Main Street, Avilla, IN, 46710, US

(21) Appl. No.: 09/870,921

(22) Filed: May 31, 2001

(51) Int. Cl. F16D 31/02

(52) U.S. Cl. 60/419

(57) ABSTRACT

A hydraulic system, particularly suitable for use in a work machine, is provided with a hydraulic pressure source. A hydraulic transformer has an inlet and an outlet, with the inlet being coupled with the pressure source. At least one hydraulic motor has an inlet. The hydraulic transformer and each hydraulic motor are disposed within a housing. The housing defines at least one fluid conduit which fluidly interconnects at least one hydraulic motor inlet with the hydraulic transformer outlet and/or pressure source. Since the housing defines the fluid conduits interconnecting the various components therein, the hydraulic pressure may be increased over conventional operating pressures.

### TECHNICAL FIELD

The present invention relates to hydraulic systems, and, more particularly, to hydraulic systems utilizing a hydraulic transformer and hydraulic motor.

### BACKGROUND

Hydraulic systems typically receive high pressure hydraulic fluid from a pressure source and convert the hydraulic input energy into mechanical output energy. It is known to provide a hydraulic system with a hydraulic transformer which amplifies the hydraulic pressure received at the inlet thereof. The hydraulic transformer may provide higher pressure hydraulic fluid to a downstream load such as a hydraulic motor, hydrostatic transmission, hydraulic cylinder, etc. The hydraulic transformer includes an inlet and an outlet which are continuously fluidly coupled between the high pressure source of hydraulic fluid and the downstream load.

A problem with a hydraulic system as described above is that the hydraulic transformer and downstream loads are typically coupled together via hydraulic hoses, couplings, etc. Typically, such hydraulic hoses have a maximum operating pressure of around 5,000 pounds per square inch (psi). However, the hydraulic transformer, hydraulic motor, etc. may be capable of operating at pressure higher than 5,000 psi. The operating range of a particular component, such as a hydraulic motor, at which the hydraulic component may operate efficiently is generally a function of the input pressure thereto. If the input pressure could be increased above the 5,000 psi limit normally associated with fluid hoses, etc., it may also be possible to extend the operating range at which a hydraulic component may operate efficiently.

The present invention is directed to overcoming one or more of the problems as set forth above.

### SUMMARY OF THE INVENTION

In one aspect of the invention, a hydraulic system is provided with a hydraulic pressure source. A hydraulic transformer has an inlet and an outlet, with the inlet being coupled with the pressure source. At least one hydraulic motor has an inlet. The hydraulic transformer and each hydraulic motor are disposed within a housing. The housing defines at least one fluid conduit which fluidly interconnects at least one hydraulic motor with the hydraulic transformer outlet and/or pressure source.

In another aspect of the invention, a method of operating a hydraulic system is provided with the steps of: positioning a hydraulic transformer and at least one hydraulic motor within a housing, the hydraulic transformer having an inlet and an outlet, each hydraulic motor having an inlet; coupling the hydraulic transformer inlet with a pressure source; defining at least one fluid conduit with and within the housing which fluidly interconnects at least one hydraulic motor inlet with the hydraulic transformer outlet and/or pressure source; and conveying hydraulic fluid through the at least one fluid conduit.

### BRIEF DESCRIPTION OF THE DRAWINGS

FIG. 1 is a schematic illustration of an embodiment of a hydraulic system of the present invention incorporated within a work machine.

### DETAILED DESCRIPTION

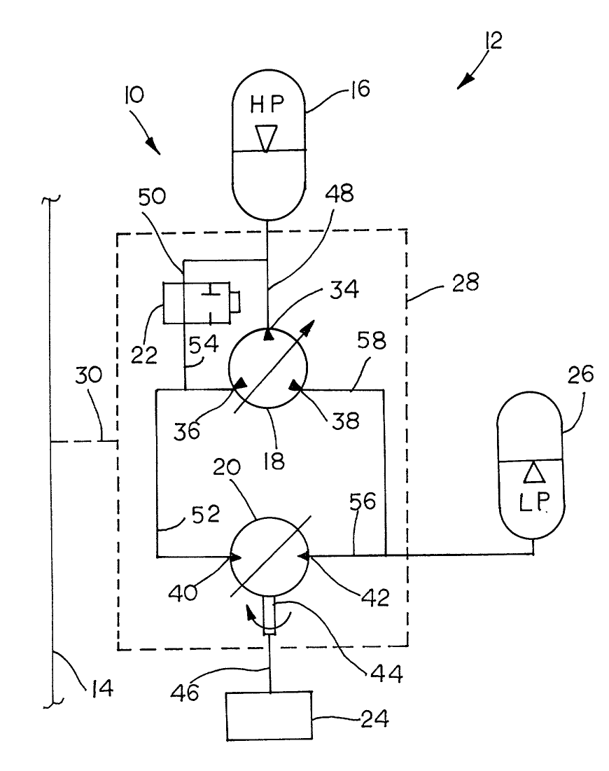

Referring now to FIG. 1, there is shown an embodiment of a hydraulic system 10 of the present invention. In the embodiment shown, hydraulic system 10 is part of a work machine 12 such as a tractor, backhoe, motor vehicle, etc. Work machine 12 includes a frame 14 which carries hydraulic system 10.

Hydraulic system 10 generally includes a hydraulic pressure source in the form of a high pressure accumulator 16, a hydraulic transformer 18, a hydraulic motor 20, a bypass valve 22, a hydraulic load 24 and a low pressure accumulator 26. High pressure accumulator 16 is provided with high pressure hydraulic fluid and directly or indirectly drives hydraulic motor 20 using the high pressure hydraulic fluid.

Hydraulic transformer 18, hydraulic motor 20 and bypass valve 22 are each positioned within a common housing 28. Housing 28 is carried by frame 14, as indicated by line 30.

Bypass valve 22 may be actuated either hydraulically or electrically, depending upon the application, to shunt high pressure hydraulic fluid around hydraulic transformer 18 via line 32. Bypass valve 22, in the embodiment shown, is configured as a normally open valve so that the hydraulic fluid is only shunted around hydraulic transformer 18 when the pressure of the hydraulic fluid flowing from high pressure accumulator 16 is sufficient to drive hydraulic motor 20 at a given operating range.

Hydraulic transformer 18 includes an inlet 34, outlet 36 and a low pressure outlet 38. Inlet 34 is directly fluidly coupled with high pressure accumulator 16; outlet 36 is directly fluidly coupled with hydraulic motor 20; and low pressure outlet 38 is fluidly coupled with low pressure accumulator 26. Hydraulic transformer 18 is adjustable so that high pressure hydraulic fluid received at inlet 34 is selectively coupled with outlet 36 and/or low pressure outlet 38 to control the amount of pressure amplification flowing therethrough. For example, hydraulic transformer 18 may include a port plate or port barrel therein (not shown), in known manner, to control the pressure amplification of the hydraulic fluid flowing from outlet 36, relative to the pressure at inlet 34.

Hydraulic motor 20 includes an inlet 40 fluidly coupled with each of bypass valve 22 and hydraulic transformer 18; and an outlet 42 which is fluidly coupled with low pressure accumulator 26. Hydraulic motor 20 includes an output shaft 44 which is coupled with hydraulic load 24, as indicated schematically by line 46. Hydraulic motor 20 is selectively adjustable so as to provide output shaft 44 with a desired rotational speed and/or torque depending upon operating conditions.

Hydraulic load 24 may be of any selected type such as a hydrostatic transmission, hydraulic cylinder, etc. In the embodiment shown, hydraulic load 24 is assumed to be a hydrostatic transmission.

According to an aspect of the present invention, housing 28 defines at least one fluid conduit which fluidly interconnects hydraulic motor inlet 40 with each of high pressure accumulator 16 (via bypass valve 22) and hydraulic transformer 18. More particularly, housing 28 is formed from a cast or other material which encases hydraulic transformer 18 and hydraulic motor 20 therein. Housing 28 is cast with contours, openings, etc. which define separate fluid conduits interconnecting the various components disposed therein. The various fluid conduits within housing 28 are shown in schematic form since they may be formed in multiple manners and configurations as will be apparent to those skilled in the art. Fluid conduit 48 fluidly interconnects high pressure accumulator 16 with hydraulic transformer inlet 34. Fluid conduit 50 fluidly interconnects high pressure accumulator 16 with the inlet side of bypass valve 22. Fluid conduit 52 fluidly interconnects hydraulic transformer outlet 36 with hydraulic motor inlet 40. Fluid conduit 54 fluidly interconnects the outlet side of bypass valve 22 with fluid conduit 52, thereby coupling bypass valve 22 with hydraulic motor inlet 40. Fluid conduit 56 fluidly interconnects hydraulic motor outlet 42 with low pressure accumulator 26. Fluid conduit 58 fluidly interconnects hydraulic transformer low pressure outlet 38 with fluid conduit 56, thereby in turn coupling low pressure outlet 38 with low pressure accumulator 26. Each of fluid conduits 48-58 are defined by and within housing 28 to fluidly interconnect the various components disposed therein in the manner shown in FIG. 1.

### INDUSTRIAL APPLICABILITY

Referring again to FIG. 1, the method of operation of hydraulic system 10 will be described in more detail. Bypass valve 22 couples hydraulic motor 20 selectively either with high pressure accumulator 16 or hydraulic transformer outlet 36, depending upon an operating characteristic associated with hydraulic motor 20. More particularly, bypass valve 22 operatively couples hydraulic motor 20 with high pressure accumulator 16 and/or hydraulic transformer 18, depending upon an output speed and/or output torque associated with output shaft 44 of hydraulic motor 20. When coupled directly with high pressure accumulator 16, hydraulic motor 20 operates within an operating range corresponding to the pressure received at inlet 40. Conversely, when coupled directly with outlet 36 of hydraulic transformer 18, hydraulic motor 20 operates within an operating range corresponding to the amplified pressure received at inlet 40.

Hydraulic system 10 allows hydraulic motor 20 to operate within two different operating ranges, depending upon whether the pressure received at inlet 40 is a non-amplified pressure directly from high pressure accumulator 16 or an amplified pressure from hydraulic transformer 18. It is thus possible to utilize a smaller motor 20 over a wider range of operating conditions by providing non-amplified or amplified hydraulic fluid to the inlet thereof.

Hydraulic fluid flows between the various components (i.e., bypass valve 22, hydraulic transformer 18 and hydraulic motor 20) within fluid conduits 48-58 defined by and within housing 28. The hydraulic pressure within the various conduits 48-58 thus may operate at pressures up to the limits corresponding to the material type and thickness of housing 28. In the embodiment shown in FIG. 1, the hydraulic pressure may operate at pressures up to 10,000 psi, depending upon the particular application.

The present invention provides a hydraulic system which is capable of operating at higher hydraulic pressures than heretofore possible. This is primarily achieved through eliminating fluid hoses, fittings, etc. which typically can only operate up to pressures of approximately 5,000 psi. By placing bypass valve 22, hydraulic transformer 18 and hydraulic motor 20 within a common housing 28 in a substantially sealed manner and also defining interconnecting fluid conduits by and within housing 28, the maximum operating pressure can reach 10,000 psi, or possibly even greater depending upon the configuration of housing 28 and the pressure limits of hydraulic transformer 18, bypass valve 22 and hydraulic motor 20. By eliminating the fluid hoses, couplings, etc., assembly of hydraulic system 10 is simplified. By being able to provide hydraulic motor 20 with a higher input pressure, the operating range over which hydraulic motor 20 operates efficiently can be widened.

Other aspects, objects and advantages of this invention can be obtained from a study of the drawings, the disclosure and the appended claims.

What is claimed is:

1. A hydraulic system, comprising:
a hydraulic pressure source;
a hydraulic transformer having an inlet and an outlet, said inlet coupled with said pressure source;
at least one hydraulic motor having an inlet; and
a housing in which said hydraulic transformer and each said hydraulic motor are disposed, said housing defining at least one fluid conduit which fluidly interconnects at least one said hydraulic motor inlet with at least one of said hydraulic transformer outlet and said pressure source.

2. The hydraulic system of claim 1, said housing being adapted to accommodate fluid pressure within each said fluid conduit up to about 10,000 pounds per square inch.

3. The hydraulic system of claim 1, said housing defining at least one fluid conduit which fluidly interconnects each said hydraulic motor inlet with at least one of said hydraulic transformer outlet and said pressure source.

4. The hydraulic system of claim 1, said housing defining at least one fluid conduit which fluidly interconnects each said hydraulic motor inlet with one of said hydraulic transformer outlet and said pressure source.

5. The hydraulic system of claim 1, including a bypass valve disposed within said housing and operably coupling at least one said hydraulic motor inlet selectively either with said pressure source or said hydraulic transformer outlet, said housing defining at least one fluid conduit coupled with said bypass valve.

6. A work machine, comprising:
a frame; and
a hydraulic system carried by said frame, said hydraulic system including:
a hydraulic pressure source;
a hydraulic transformer having an inlet and an outlet, said inlet coupled with said pressure source;
at least one hydraulic motor having an inlet; and
a housing in which said hydraulic transformer and each said hydraulic motor are disposed, said housing defining at least one fluid conduit which fluidly interconnects at least one said hydraulic motor inlet with at least one of said hydraulic transformer outlet and said pressure source.

7. The work machine of claim 6, said housing being adapted to accommodate fluid pressure within each said fluid conduit up to about 10,000 pounds per square inch.

8. The work machine of claim 6, said housing defining at least one fluid conduit which fluidly interconnects each said hydraulic motor inlet with at least one of said hydraulic transformer outlet and said pressure source.

9. The work machine of claim 6, said housing defining at least one fluid conduit which fluidly interconnects each said hydraulic motor inlet with one of said hydraulic transformer outlet and said pressure source.

10. The work machine of claim 6, including a bypass valve disposed within said housing and operably coupling at least one said hydraulic motor inlet selectively either with said pressure source or said hydraulic transformer outlet, said housing defining at least one fluid conduit coupled with said bypass valve.

11. A method of operating a hydraulic system, comprising the steps of:
positioning a hydraulic transformer and at least one hydraulic motor within a housing, said hydraulic transformer having an inlet and an outlet, each said hydraulic motor having an inlet;
coupling said hydraulic transformer inlet with a pressure source;
defining at least one fluid conduit with and within said housing which fluidly interconnects at least one said hydraulic motor inlet with at least one of said hydraulic transformer outlet and said pressure source; and
conveying hydraulic fluid through said at least fluid conduit.

12. The method of claim 11, said conveying step including conveying said hydraulic fluid within said at least one fluid conduit up to a maximum possible pressure of about 10,000 pounds per square inch.
